(19) United States
(12) Patent Application Publication
(10) Pub. No.: US 2013/0110698 A1
(43) Pub. Date: May 2, 2013

(54) SYSTEM FOR KNOWLEDGE CREATION

(71) Applicant: Ann Racuya-Robbins, Arlington, VA (US)

(72) Inventor: Ann Racuya-Robbins, Arlington, VA (US)

(21) Appl. No.: 13/680,062

(22) Filed: Nov. 18, 2012

Related U.S. Application Data
(63) Continuation-in-part of application No. 12/599,346, filed on Nov. 9, 2009, now Pat. No. 8,359,275.

(30) Foreign Application Priority Data
Jul. 24, 2007 (US) PCT/US07/62466

(51) Int. Cl. G06Q 40/04

(52) U.S. Cl. CPC G06Q 40/04
USPC 705/37

(57) ABSTRACT

In order to establish a system that maximizes the creation and benefits of human knowledge for the most people, including the wealth knowledge generates, the nature of the knowledge creation process itself must be understood and embedded in the system. The invention is the system for enabling knowledge creation and the wealth knowledge generates in which participants retain ownership to his or her knowledge and most of the wealth the knowledge generates.

The present invention is the system designed specifically to enable knowledge creation, the system that increases the wealth generated from knowledge creation, where the people who create the knowledge retain ownership and control of that knowledge, as well as most of the revenues generated by that knowledge. The system providing a democratic and peaceful way to share, exchange, market, distribute and broadcast the knowledge.

Today we live in a world where people's quality of life and health varies greatly across the globe. Some people and groups have extraordinary privilege and others have less than is needed to survive. There is a sense in our world that a scarcity exists in resources and possibilities of a good life for many.

This disparity in people's quality of life can be indexed to the kind of work a person does and how a person is rewarded for his or her work. The value of a person's work is measured largely by how much money a person is paid for her or his time.

When great disparities exist in who has her or his human needs and wants satisfied, a general sense of injustice emerges. This sense of injustice is not a matter of ideology but something that emerges from a sense of our common humanity. It is a kind of common sense. The invention exposes the realization that neither scarcity nor injustice are a clear picture of life but are limitations created by how people have organized themselves. The invention is an alternate and improved way of creating and sharing knowledge based on a sense of abundance and justice.

In our current world, knowledge is often hidden or hoarded. This hiding or hoarding occurs because today owning certain kinds of knowledge is central to the creation of wealth and people's livelihood. Quite naturally then, people feel the need to hide, obfuscate and hoard knowledge. Further the knowledge creation process is often exploited by individuals other than those who created the knowledge. This current system breeds distrust and to a certain extent isolation and loneliness, a sense of being disconnected from each other. This sense of isolation, of being unappreciated and distrustful of others, seems the price of much of contemporary life. This kind of world does not support nor is it conducive to the knowledge creation process except for a relative few. Today, for the vast majority of people on the earth,the chances are greatest that the things we know and have to share will not be heard or valued but by a few, if that.

Currently no system exists to provide a secure and efficient market for people to justly exchange what he or she knows, retain ownership of his or her knowledge and receive most of the wealth that knowledge creates. One reason for the unjust exchange of what he or she knows is the lack of a method and system to equalize the disparities in value between currencies. People whose currency is valued less have less purchasing power from his or her knowledge revenues regardless of the merits of his or her knowledge otherwise.

While variation in how people's time is valued is a natural consequence of individual differences, great disparities among how people's time is valued is counterproductive to increasing the wealth of the world and the equitable distribution of that wealth brought to the human community by each and every life.

Currently, people whose time is more valuable are likely to have more resources to support his or her life than other people. A person whose time is not valued is likely to have a restricted life and health and his or her knowledge will likely die sooner and be lost to others because that person is likely to be overlooked, ignored and even die sooner.

Today, even for the few whose life has better quality, much of his or her knowledge is lost because only a select set of life activities are currently valued. Systems that value some people's knowledge while ignoring or not valuing other people's knowledge cannot see nor develop the abundance of wealth from knowledge. It is arbitrary and an oversight to decide that some people's knowledge is not valuable when you don't know what that knowledge is. Such systems restrict and are not optimized to enable knowledge creation and the wealth knowledge generates.

Some governments are more dedicated than other governments to increasing all peoples' participation in the current highly competitive system and these governments are democratic and are the preferred emergence ground for the invention as a system of knowledge creation and wealth generation and distribution.

The invention is the system, subsystems, methods, processes, devices, apparatus, techniques, and computer and software applications for implementing the system, to overcome the above problems.

An advantage of the invention is that the vast majority of people on earth can participate in the invention and be rewarded including retaining rights to his or her knowledge and receiving revenues for sharing his or her knowledge.

Another advantage of the invention is that by using global communication networks and infrastructure, including but not limited to the internet, mobile telecommunication services and the World Wide Web as methods of knowledge creation and sharing, the invention can provide an efficient, secure, safe, practical and just system that enables and amplifies knowledge creation and wealth generation for its participants.

An object of the invention is to provide a system, and subsystems including methods, processes, devices and apparatus, databases, computer subsystems and software and communication applications, that are characterized by the stated independent claims. The preferred embodiments of the invention are disclosed in the dependent claims.

The invention is based on the realization that every activity a person does creates knowledge and that sharing knowledge from life activities amplifies the total knowledge created, and often in unexpected ways.

This realization—that every activity a person does creates knowledge and that sharing knowledge from life activities amplifies the total knowledge created, and often in unexpected ways—is an expression of three key insights into the process of knowledge creation. They are: 1. doing a life activity creates emergent/new knowledge of life activities, and 2. knowledge sharing is a central method of creating and amplifying the benefits and rewards of knowledge, 3. just and fair sharing is the best way to amplify the benefits and rewards of knowledge creation for the most people.

The invention is based on the realization that the best environment for knowledge creation and wealth generation is a system that is globally accessible through communications networks such as the internet and the World Wide Web among others and that is just, secure, safe, equitable and generous. The above named insights (conceptualizations) enable us to see better how the invention is best suited to enabling knowledge creation and the wealth that can be generated from the knowledge.

An advantage of the invention is that it provides a system that by valuing more people, and their knowledge, increases the amount of wealth generated and provides a just system for wealth distribution.

The invention,for the first time, provides a creative, just, secure, fun, and fast system wherein millions of people can work together to solve problem(s) and create new opportunities for life on earth.

In the following the invention will be described in greater detail by means of preferred embodiments and with reference to the accompanying drawings, in which:

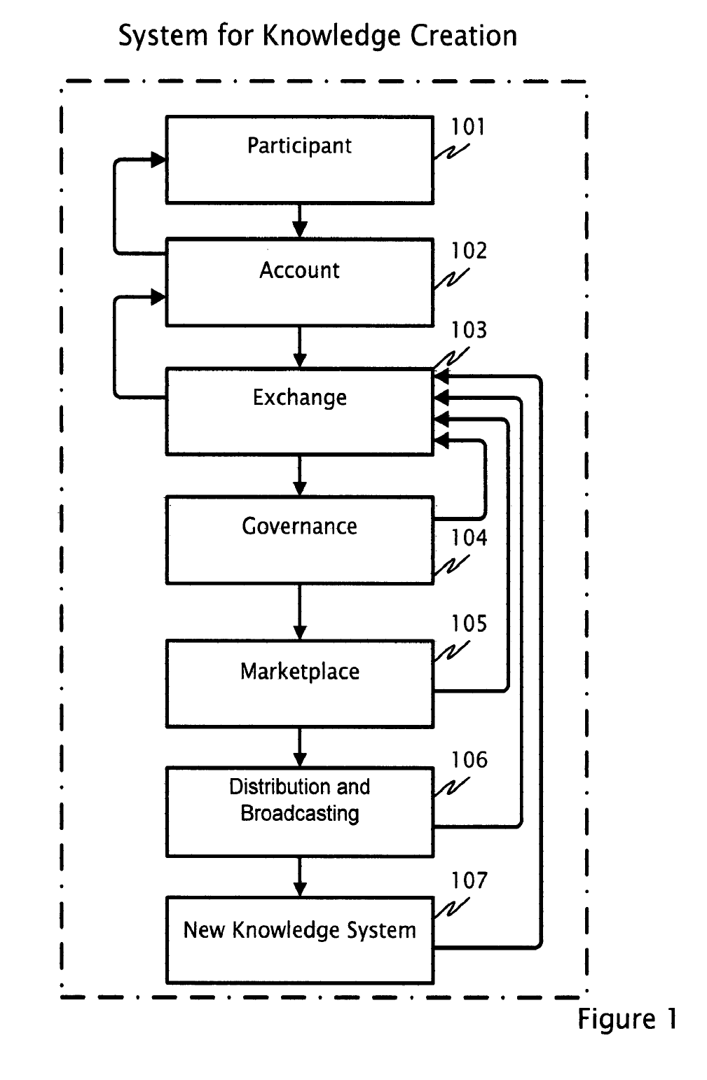

FIG. 1 illustrates a simplified exemplary embodiment of the invention.

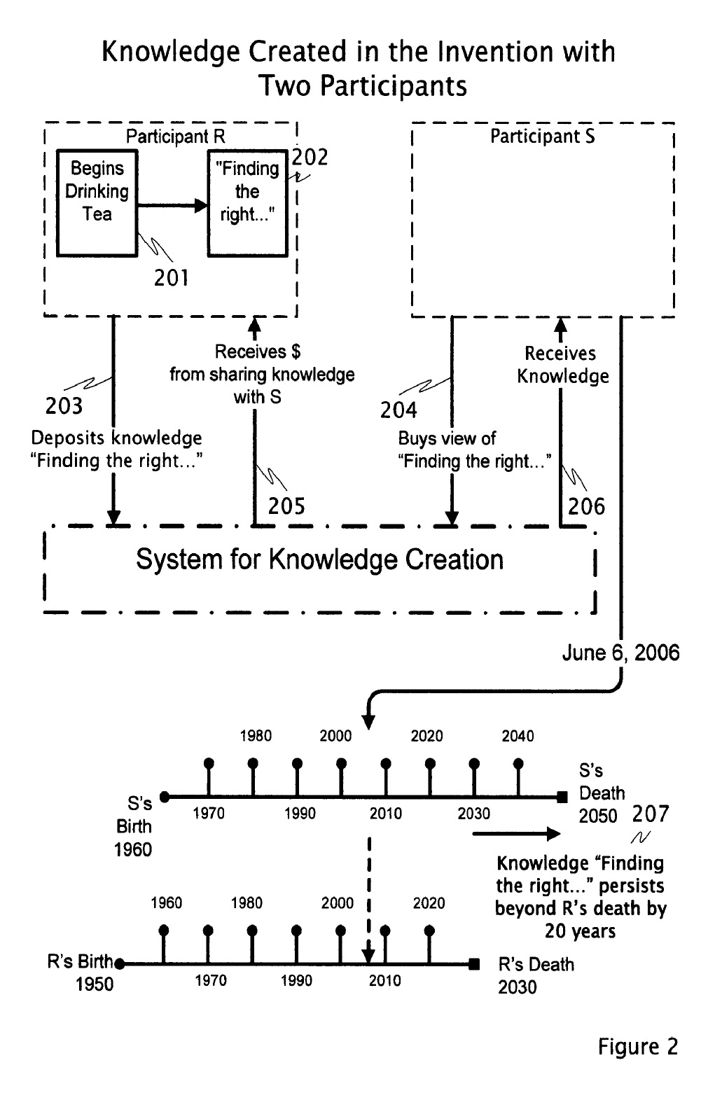

FIG. 2 shows a simplified exemplary embodiment of the key process and consequence of the invention with two participants.

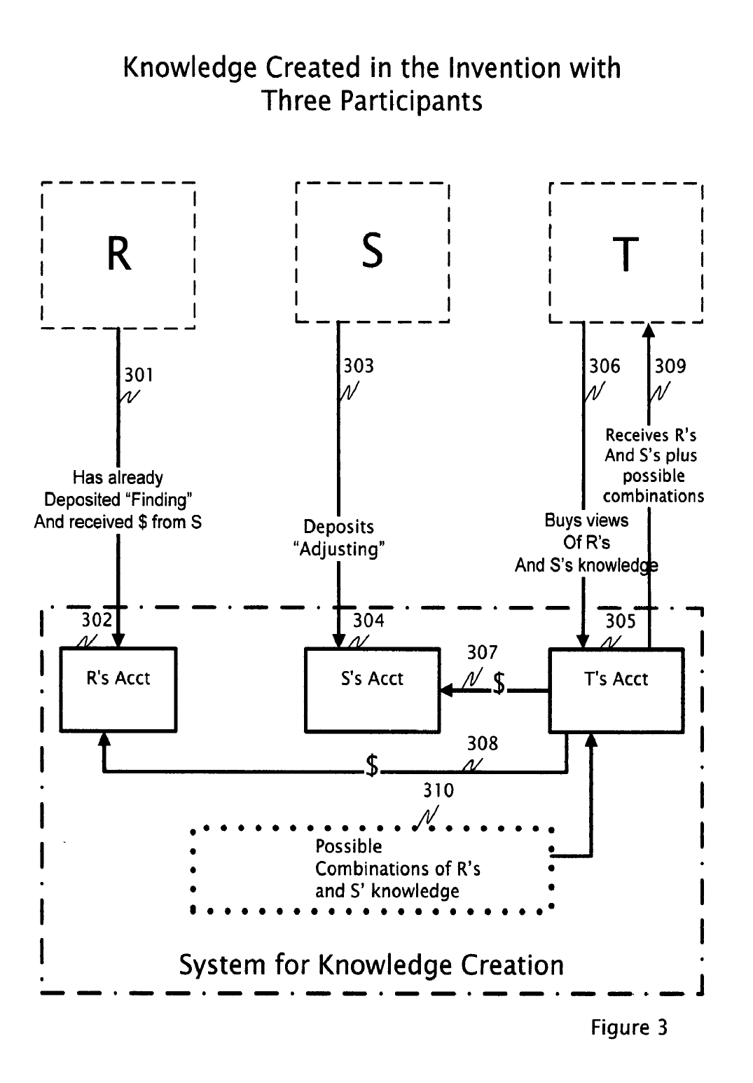

FIG. 3 shows a simplified exemplary embodiment of the invention with three participants.

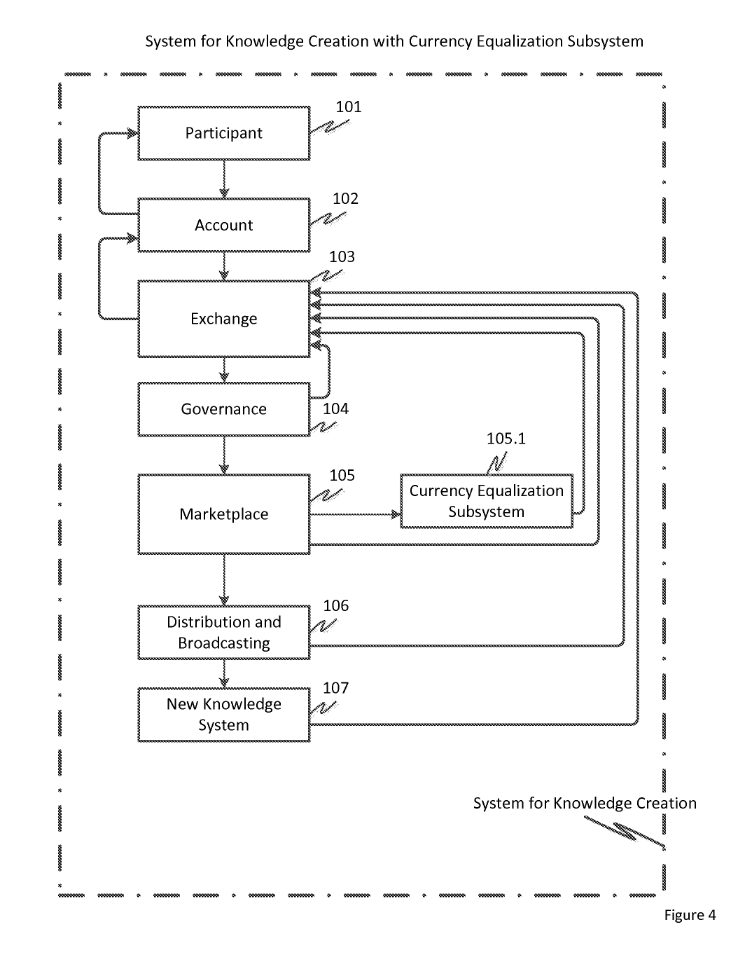

FIG. 4 illustrates a simplified exemplary embodiment of the invention's “Currency Equalization System” for equalizing disparities in currency valuation in the marketplace subsystem so that people whose currency is less valued are not unjustly disadvantaged when buying or selling knowledge.

The present invention is applicable for any kind of knowledge creation and wealth generation from that knowledge, except knowledge that destroys or ends life.

The present invention establishes a system that is global and self sustaining including subsystems,organizational infrastructures, processes, methods, devises, techniques and apparatus, including internet facilitated computer subsystems and software programs, computer architecture including database architecture and management subsystems and justice subsystems for knowledge creation, knowledge recording and the equitable sharing of knowledge available over the internet and the World Wide Web.

In the following,the present invention is described by using as a simplified example, a system that enables and supports knowledge creation and wealth generation from knowledge about daily life where the invention may be applied,without restricting the invention to knowledge about daily life, however.

To see how the invention works in the example a specific piece of knowledge about daily life has been chosen, namely, knowledge about how a person found the right temperature for drinking tea while not burning her or his fingers or tongue. The specific example of knowledge a bout daily life follows: One day participant R decides to try drinking tea (ref. 201) instead of coffee first thing in the morning because R has been having trouble with too much stomach acid in the morning. R who lives in Santa Fe, N.M., USA, in the mountains at 7000 feet of elevation, discovers that R likes drinking tea. R has already opened an account (ref. 302) with the System for Knowledge Creation.

On Jun. 5, 2006 R deposits (ref. 203) the following knowledge into R's account (ref. 302):

“ . . . I fill my cup with water and put it in the microwave for 1 minute 35 seconds and then put my tea bag in to steep while I prepare my breakfast . . . ) chose to microwave rather than boil the water because it is faster and when I boiled the water, I always wanted to take a sip of tea too soon and burned my tongue. But when I microwave the water, the cup gets too hot and I often burn my fingers because the cup takes too long to cool down and I don't want to hold my cup with a pot holder.

This morning I used a cup I had never tried before. When I reached into the microwave after heating, I could tell the cup was not too hot to touch and when I tested the water with my finger the temperature was just right. I sat down and drank my tea with my breakfast. This brought a smile to my face and made the start of my day much better. I wondered why this cup didn't get too hot and one thing I noticed was that the handle had a different shape, with a place for your thumb that lifted up and away from the rest of the handle. While I am not sure this shape to the handle is the reason the cup was not too hot I do now know that the right cup makes a big difference and that it is possible to find the right temperature for drinking tea that is fast and allows me to use the microwave. I would like to explore this discovery more. Ever since I discovered this I have wanted to share this simple discovery that made a big difference in my day.”

R decides to title the knowledge deposit “Finding the right temperature for drinking tea.”When R saves the deposit the knowledge goes to the Exchange (ref. 103) in FIG. 1, where it is logged and returns a receipt to R's account (ref. 102) in FIG. 1 for R's knowledge as recorded and deposited on Jun. 5, 2006.

R then decides to find out if R can generate revenues from R's deposited knowledge, “Finding the right . . . ” R browses over the internet the “Calls for Knowledge of Daily Life” database, (ref. 105) in FIG. 1, in the marketplace, where participants can list requests for knowledge on a variety of aspects of daily life. R's browsing and searching details are logged in the Exchange (ref. 103) and the browsing and searching details are returned via receipt to R's account (ref. 102) in FIG. 1.

After browsing and searching R still doesn't find any requests for “Finding the right . . . ” in the “Calls for Knowledge” section of the marketplace (ref. 105) in FIG. 1. R then decides to post “Finding the right . . . ” in the “Knowledge Available” section of the marketplace (ref. 105). R's decision to post R's knowledge to the marketplace is logged in the Exchange (ref. 103) which is governed by Governance (ref. 104) in FIG. 1 including the system's Constitution and Founding Principles and the policies, rules and remedies in the system's “Dispute Resolution Subsystem”. A receipt is sent to R's account (ref. 102). R now has many options. Among R's options R can decide to float a price for the knowledge and/or find out how many people record an interest in R's “Finding the right . . . ” in the “Knowledge Available” section of the marketplace.

R decides to find out how many people record an interest.

R's request to find out how many people record an interest is logged in the Exchange (ref. 103) and a receipt with the decision particulars is sent to R's account (ref. 102).

One day later, on Jun. 6, 2006 a message is sent from the Exchange (ref. 103) to R's account (ref. 102) that 150 people are interested in finding out about R's knowledge. R decides to price R's knowledge at $0.50 per view. 100 people decide to purchase a view of R's knowledge. The particulars of the offer, agreement and purchase are logged into the Exchange (ref. 103) and a receipt with the particulars is returned to R's account (ref. 102). By logging and receiving receipts in R's account (ref. 102), R's ownership in the chain of knowledge transactions is documented and secured.

The buyer's money is put into an escrow-like place in the Exchange (ref. 103) and delivered (ref. 208) to R's account (ref. 102) as the buyers view the knowledge. In one day R receives $50.00 for R's knowledge. All of the aspects of the transaction are governed and are securely and safely kept. R receives $50.00 for the knowledge “Finding the right . . . ” as recorded and deposited on June 5 in R's account (ref. 102). This knowledge had no recognized market, nor monetary value, previously.

Both buyers and sellers are knowledge contributors to the System for Knowledge Creation and all have accounts (ref. 102) where his or her activities are logged and documented. This logging through the Exchange (ref. 103) forms the basis for dispute resolution and establishing better and more just mechanisms of governance.

R can continue to make decisions about the marketing, development, distribution and broadcasting of R knowledge “Finding the right . . . .” For example R can decide to add a picture of the cup for $0.10 per view. All R's decisions are logged in the Exchange (ref. 103) and returned via a receipt to R's account (ref. 102). All activities of the Exchange (ref. 103) are governed (ref. 104).

In the example above, R freely deposits his or her knowledge into the invention through an account (ref. 102). R is motivated to deposit his or her knowledge in order to receive revenues, although R can elect not to receive revenues but rather donate R's knowledge to the Invention's Public Library or someone else's account (ref. 102). R is also motivated to deposit her or his knowledge because R feels delight and excitement in discovering something R didn't know before and wants to share it with others. It is a common human experience to feel delight, excitement and wanting to share something he or she has discovered. All of these feelings can make R feel he or she has not only helped his or herself but has also made a contribution to others, leaving R with a sense of community and self worth and esteem.

One of the buyers (ref. 205) of R's knowledge “Finding the right . . . ” is participant S in FIG. 2. Here the implication can be seen clearly that the limits of knowledge creation are indexed to the number of participants and length of their lifetimes (ref. 209). Systems, such as the invention, that protect and enhance life also protect and enhance knowledge.

FIG. 2 represents the invention's central realization that any life activity contains the knowledge creation kernel which is that emergent/new life activities appear freely from living and reliving a life activity (ref. 201 and 202). While FIG. 2 shows that the emergent/new life activity, in this case “Finding the right . . . ” (ref. 202) relates to the life activity R was doing—drinking tea—the emergent/new life activity may have related to a life activity about something else entirely. A very simple personal example of the emergent/new life activity related to a life activity about something else entirely is the experience many of us have had namely, that when watching or hearing something creative being done by someone our own ideas, often emergent/new and unrelated ideas are stimulated. Artists and writers, in general are familiar with this experience. This is a type of resonance principle that exists in the knowledge creation process when knowledge is shared.

The exact piece(s) of the emergent/new life activity(s) that is created and when it is created remain largely unknown. For the purpose of the present invention it is enough to know that emergent/new life activity is integral to the knowledge creation process itself.

Once created the emergent/new life activity is now available to be shared and used by oneself and by others.

Every emergent/new life activity adds to the number and range of possible life activities available in the invention for participants to use. When a person dies before sharing a person's knowledge, the “life” of that knowledge ends.

FIG. 2 illustrates that when R shares the knowledge “Finding the right . . . ” through the invention (ref. 203), the knowledge “Finding the right . . . ” persists at least twenty years beyond R's life (ref. 207).

When the knowledge creation process is further shared and recorded with three participants as in FIG. 3 of the invention,the total knowledge created “blooms” with a large number of variations or combinations of a life activity (ref. 312) and emergent/new life activities (ref. 301) and (ref. 306) made available to others. This blooming is expressed in FIG. 3 as possible combinations of the participant R's and S's knowledge (ref. 312). It is the invention that creates and/or enables the combinations. The total knowledge created while dependent on R and S is no longer bounded by the lives of R and S that created it, but is now available in varying proportions for any participant to use and benefit from. In this way the invention enables the knowledge created to exist until all life is dead.

In FIG. 3 R has already deposited “Finding the right . . . ” and received revenue (ref. 301) from S's purchase of “Finding” in R's account (ref. 302) in the Invention. S has already received “Finding” in S's account (ref. 304).

In FIG. 3 participant S, who lives in Rio de Janeiro, Brazil, at sea begins using “Finding the right . . . ” but notices that the temperature is still too hot. S continues to experiment with R's “Finding the right . . . ” and finds that the right temperature is achieved after microwaving for 1 minute instead of 1 min 35 seconds. S decides that the shorter heating time may be due to S residing at sea level. S titles S's discovery“Adjusting heating time for sea level” (ref. 304). While S is not sure the difference is due to residing at sea level, S decides to deposit S's discovery“Adjusting” into S's account (ref. 304) in the System of Knowledge about Daily life.

Participant T in FIG. 3 also drinks tea and is interested in finding the right temperature. Participant T, who lives in Omaha, Nebr., USA, at 1187 feet of elevation, opens an account (ref. 305) with the System for Knowledge Creation about Daily life to look for knowledge about finding the right temperature for drinking tea using a microwave. T decides to buy a view of R's “Finding the right . . . ” and S's “Adjusting heating time for sea level” (ref. 306).S receives revenues from T in S's account (ref. 307). R receives T's revenue in R's account (ref. 308). Surprisingly, T not only receives R's and S's knowledge (ref. 309) but T also receives possible combinations or mixes (ref. 310) of R's knowledge and S's knowledge. Here the amount of knowledge created is much greater than R's and S's knowledge alone.

In FIG. 3 it is possible to see that the more participants there are in the invention the more knowledge the invention will enable to be created and at an unprecedented speed.

FIG. 3 is an example of knowledge from one life activity shared by three participants which creates an abundance of possible combinations that can be used. Today the earth has 6 billion people, most of whom are eligible to participate in the invention.

Because emergent/new life activities arise freely and naturally in the knowledge creation process there is no need to force its appearance. While discipline and other methods may increase the likelihood of emergent/new life activities' appearance it is not necessary. Emergent/new life activity is an expression of a person living freely and naturally and a person's need and will to survive.

In order to build the system, the first step is to create the governance subsystem. Without a strong and just governance subsystem, stealing, hiding, hoarding and obfuscating can flourish unchecked and limit the invention's knowledge and wealth generating capacity for the most people. Further the invention's governance subsystem begins by establishing founding principles and a Constitution. The invention's founding governance subsystem is illustrated in a preferred exemplary description of the governance subsystem as described below.

### The Constitution of the Invention

### Declaration of the Establishment of the Invention

The invention is established to create a vibrant and just community wherein all people can share their knowledge about daily life and elect to be compensated for what they know.

The invention's ability to make this Declaration is due to the democratic and just qualities of the Constitution of the United States of America and the just qualities of the development of the United States of America over time.

Further the invention's creation and development stands on the shoulders of:
the native people of the Americas including the Iroquois Confederacy that first established democratic practices here
the native people who handed down to current generations the beauty of the Americas' land
and the Great Giving (please see The Constitution of Mercy—forthcoming) of the countless named and unnamed men and women from around the world that have spent their lives in support of the living earth, justice for all and the power of the free human spirit.

### Founding Principles

The invention holds as self-evident that:
the knowledge of life is the essential labor of every life.
every life has an inalienable right to and responsibility for its knowledge.
every life has a right to revenues generated through or from the shared use of its knowledge.
age encodes in its unique signature an intrinsically creative insight into living.
the world is bountiful with human creativity.
the greatest value of creativity is reached when it is shared in a respectful and just manner.
democracies and institutions within democracies are living entities that can and must grow, change and refine themselves in order to create more just, compassionate and free societies.
no life should end without its legacy being valued and that each life develops knowledge that is irreplaceable and needed by the human community.
every life has its knowledge and that taken together all this life knowledge is a most powerful force for good in the world.
every participant in the invention must tell the truth.
the invention is a participant.
no participant should steal or help another participant, person or entity to steal other participants' knowledge.
the protection of children's knowledge and general well being up until the age of majority is among the highest responsibilities of every participant.
the appreciation of creativity and creative acts in oneself and others stimulates more creativity in oneself and in others.
the safety and security of participants' and the invention's knowledge is a shared responsibility. That the invention is responsible for making good faith efforts to ensure the safety of the invention's systems and the participant is responsible for making good faith efforts to secure the access of the participant to the invention.
this list holds the seeds and the promise of the invention's ultimate unfolding.

### Preamble

The invention is governed by the laws of the United States of America and the treaties to which the US is a signatory. Further the invention is governed by its own democratic Constitution, Bill of Rights and Responsibilities and System of Justice that the invention that will be evolving, amending and restructuring from time to time.

### Article I Amending the Constitution

Upon completion of the invention's Constitution approximately 5 years after the invention's creation the Constitution will have in place democratic procedures and mechanisms for amending and improving itself, establishing policies, rules and regulations. While the list of Founding Principles of the invention may not yet be complete the principles articulated under Founding Principles cannot be removed from the Constitution.

The Constitution will include compassionate, brave and just methods and mechanisms of enforcement and remedies for abuse of its Constitution, stated Founding Principles, rights, responsibilities, policies, rules and regulations. The invention will build on the wisdom and traditions from around the world.

### Article II

### Dissolving and Transforming the Invention

Upon completion of the invention's Constitution, the Constitution will have in place a set of rules for the orderly dissolution and transformation of the invention if the invention ceases to be a force for good in the world.

### Article III System of Justice

### Section I Judicial Power

(to develop,administer and adjudicate a set of rules of participant conduct based on Participant's Rights and Responsibilities.)

### Section II Enforcements Random

audits of the Exchange logs

Supervised analysis of the Exchange logs

Person(s) responsible for the Exchange are elected

### Section III Remedies

To Begin—a simple set of consequences.

### Article IV

### Participant's Rights and Responsibilities

### Section I Participant's Rights

The participant owns the knowledge in the participant's account.

The participant can make, and in some cases must make decisions about the participant's knowledge including:
how, if at all, to assign the rights to the participant's knowledge
how to pass on the rights to the participant's account
if and how to have the participant's knowledge distributed on Broadcasting
how to display the participant's knowledge in a range of display formats offered to the participant by the invention possibly including new display formats suggested by the participant.
how and when to add and/or edit the knowledge in the participant's account
when to close the participant's account with the invention.
The participant has the right to invoke the Dispute Resolution System of the invention, where the ability to pay legal fees is equalized such that a participant with greater financial resources cannot unjustly prevail over participants with fewer financial resources.
electing the person(s) responsible for the Exchange.
The participant has the right to invoke the Currency Equalization System that equalizes disparities in currency valuation.
That this list holds the seeds and the promise of the invention's ultimate unfolding.

### Section II Participant's Responsibilities

The participant is accountable for attesting truthfully that the participant is:
the originator of knowledge in the participant's account
the owner of knowledge in the participant's account
has not assigned the participant's rights before depositing the participant's knowledge in the invention.
not the owner but has been assigned the rights to this knowledge by someone-else
not reporting on a third party conversation where the participant was not present
may be contacted at the location given to the invention
is not depositing illegal content in the invention including Child Pornography, Defamatory or libelous speech.
is not depositing adult pornography. As to pornography the decision of the invention is in its sole and absolute discretion is final.
is not contributing content for violent or terrorist purposes and/or is not encrypting or obfuscating violent or terrorist knowledge in order to deposit and transfer this knowledge through the invention.
is not depositing any form of malware, including viruses, worms and new forms.
In case of disputes,the participant will use the invention's Dispute Resolution Subsystem.
electing the person(s) responsible for the Exchange.
That this list holds the seeds and the promise of the invention's ultimate unfolding.

After creating the governance subsystem the invention needs to create the Exchange and Marketplace where information about the invention and participant's interaction with the invention are recorded and returned to the participant. In this way the participant retains an interest in and access to how the system is recording and sharing the participant's knowledge.

The next step is to provide a media-rich way to distribute and broadcast the participant's knowledge. The number and richness of the ways in which a participant's knowledge is distributed allows greater amplification of the wealth generating capacity of the knowledge.

The last step is to review what the invention knows including about itself, in order to improve and innovate in the invention itself and in ways that are not expected. It is an opening or clearing left in the invention so the emergent/new is anticipated and welcomed when it arrives. See FIG. 1.

In general,while extracting knowledge from the knowledge creation process, including emergent/new life activity may be possible the invention shows that not only is extraction without the participant's informed consent not practical or just but it actually diminishes the freedom and privacy that created the knowledge in the first place.

In general, when one participant attempts to take, or force the extraction of another participant's knowledge,that first participant is likely to feel violated, injured and reluctant or even outright refusing to participate in the extraction. Since the invention itself is a participant, the invention is prohibited from extracting another participant's knowledge without the participant's informed consent. The invention provides a secure and just operating environment where a participant can control the deposition, sharing, development, marketing, broadcasting and governance of his or her knowledge.

The invention embodies the most practical, fun, fast, efficient and just way to gather knowledge from the knowledge creation process and create the most wealth for participants.

The full description of the implications of the conceptualizations in the knowledge creation process in the invention lies beyond the scope of what is necessary to understand the present invention. The intention here is to lay the essential framework of conceptualizations of the knowledge creation process so that the invention can be more fully understood.

In summary, there are three principal limitations on how much knowledge can be created by a person. One limitation is the length of a person's life. The second is the number of life activities a person can do. The third limitation is somewhat unexpected and is how much knowledge a person is able to share. In this way knowledge sharing becomes a central aspect of knowledge creation and is highly favored, but not forced in the invention. In a common sense way sharing knowledge allows the knowledge to live on in others.

Because the invention maximizes the wealth of the invention and for its participants, and the invention's wealth is based on knowledge, more than materials and natural resources, the pressure on natural resources is diminished giving the earth a better chance to provide life essential resources for people. In fact in many cases the knowledge of something alone may be sufficient development of something.

Because the knowledge creation process is recognized and supported by the invention,the invention itself will become dramatically more creative and better able to support the knowledge creation process.

Because the invention supports, facilitates and amplifies knowledge creation through sharing, revenues generated are amplified and many more people are able to provide for themselves and others. In the invention the participants involved in the knowledge creation process will increase their chances of surviving and flourishing. The full description of the implications of the invention lies beyond what is necessary to understand the invention. But these conceptualizations and the invention built on them exemplify a system through which a person's survival is improved when the group survives.

1. The Currency Equalization System of the marketplace subsystem operably connected to said computer exchange subsystem that equalizes unjust differences in currency valuation between account users.

2. The system of claim 1, further configured to:
notify said account user when a currency valuation disparity exits for said account user.

3. The system of claim 1, further configured to:
equalize differences in currency valuation among account users;
wherein if said seller account user's currency is less valued than said buyer account user's currency the said seller account user will not have unjustly reduced purchasing power revenue from the purchase of said seller account user's knowledge by said buyer account user.
